(19) United States
(12) Patent Application Publication
(10) Pub. No.: US 2014/0289617 A1
(43) Pub. Date: Sep. 25, 2014

(54) TOOL SUPPORT FOR CONTENT REVIEW

(71) Applicant: Infosys Limited, Bangalore (IN)

(72) Inventor: Harish Krishnan Rajagopalan, Maharashtra (IN)

(73) Assignee: Infosys Limited, Bangalore (IN)

(21) Appl. No.: 14/214,061

(22) Filed: Mar. 14, 2014

(30) Foreign Application Priority Data
Mar. 20, 2013 (IN) 1203/CHE/2013

(51) Int. Cl. G06F 17/24; G06F 17/27

(52) U.S. Cl. CPC G06F 17/24; G06F 17/27
USPC 715/256

(57) ABSTRACT

The present technique is a system and method that involves a review tool that supports manual and automated content review, defect log creation, and quantitative defect analysis. The present system supports a wide variety of defect categories that help reviewers to perform a comprehensive content review and provide real time feedback to the content developers to enhance the efficiency of content development. The quantitative defect analysis performed using the present technique enables to assess the competencies and skills of content development by the developers, while it can also help the content development organization to assess effectiveness of training plan or strategy adopted to train content developers.

### RELATED APPLICATION DATA

This application claims priority to India Patent Application No. 1203/CHE/2013, filed Mar. 20, 2013, the disclosure of which is hereby incorporated by reference in its entirety.

### FIELD OF THE INVENTION

The present invention relates to a tool that assists in reviewing the contents of a manuscript in general and to a content review tool providing analysis on the category and frequency of identified errors in a manuscript in particular.

### BACKGROUND

Current tools that provide auto correct options do not facilitate segregation and analysis of the identified error types and hence fail to identify commonly recurring errors.

In e-learning and training development projects, current tools do not provide error categories related to instructional design or identify errors related to non-conformance with the Microsoft Manual of Style for Technical Publications Guidelines (MSTP).

In a manuscript review, generating error logs manually and conducting error analysis is a tedious and time-consuming task. Reviewers may share comments with developers or subordinates statically leading to an inefficient and ineffective review process that does not provide insight into real-time performance in an e-learning and training development program.

### SUMMARY

To overcome such limitations, specifically in the e-learning and training development industry, the present technique allows users to generate well-formatted error logs at the click of a button within seconds. By means of the present implementation, a reviewer can easily identify the improvement areas for developers by the analytical data presented on the dashboard and create training plans to enhance the efficiency of content preparation. Present embodiments may provide a real-time input into content development efficiency and performance measurement.

Embodiments of the present invention comprise a computer implemented system and a method for reviewing manuscript contents. The method involves a reviewer defining an error to be identified in a manuscript, associating the error with a user-defined error category, a standardized comment and a suggested corrective action. The present invention technique comprises automatic tagging of the identified error with a comment box that highlights the associated error category, a standardized comment describing the error and the recommended corrective action to rectify the identified error. Embodiments may provide an insight into the predominant error categories through an interactive dashboard and a detailed report that presents data based on the statistical analysis of the identified errors.

These and other features, aspects and advantages of the present invention will become better understood with reference to the following description and appended claims.

### BRIEF DESCRIPTION OF THE DRAWINGS

These and other features, aspects, and advantages of the present invention will become better understood when the following detailed description is read with reference to the accompanying drawings in which like characters represent like parts throughout the drawings, wherein:

FIG. 1 depicts a flow chart of activities , in accordance with an embodiment;

FIG. 2 shows a representation of a user interface, in accordance with an embodiment;

FIG. 3 shows a schematic representation of an aspect of the present technique;

FIG. 4 shows an illustrative image of the manuscript reviewed in accordance with an aspect of the present technique;

FIG. 5 shows an illustrative view of the most commonly defined error categories and subcategories in accordance with the present invention;

FIG. 6 shows an illustrative overview of a developer assessment to identify the improvement areas in accordance with the present invention;

FIG. 7 is a graphical representation depicting the improvement areas across the subcategories with respect to the present technique;

FIG. 8 is a graphical representation depicting the improvement areas across the subcategories with respect to the present technique;

FIG. 9 is a graphical representation depicting errors per learning hour across error categories with respect to the present technique;

FIG. 10 depicts an embodiments of the present invention that concatenates periodic assessment results for a team of developers;

FIG. 11 is a graphical representation of a comparative performance assessment of developers in a team; and

FIG. 12 is a graphical representation of assessment of effectiveness of training plan or strategy for a given set of developers.

### DESCRIPTION

The following description is a full and informative description of the best method and system presently contemplated for carrying out the present invention, which is known to the inventors at the time of filing the patent application. Of course, many modifications and adaptations will be apparent to those skilled in the relevant arts in view of the following description in view of the accompanying drawings and the appended claims. While the system and method described herein are provided with a certain degree of specificity, the present technique may be implemented with either greater or lesser specificity, depending on the needs of a reviewer. Further, some of the features of the present technique may be used to advantage without the corresponding use of other features described in the following paragraphs. As such, the present description should be considered as merely illustrative of the principles of the present technique and not in limitation thereof, since the present technique is defined solely by the claims.

The present invention relates to a system and method of reviewing a manuscript that provides a detailed insight into the types of errors and the number of instances of occurrences of such errors. The present system may be implemented for automated identification and alternatively rectification of the identified errors while also supporting a manual review of the identified errors.

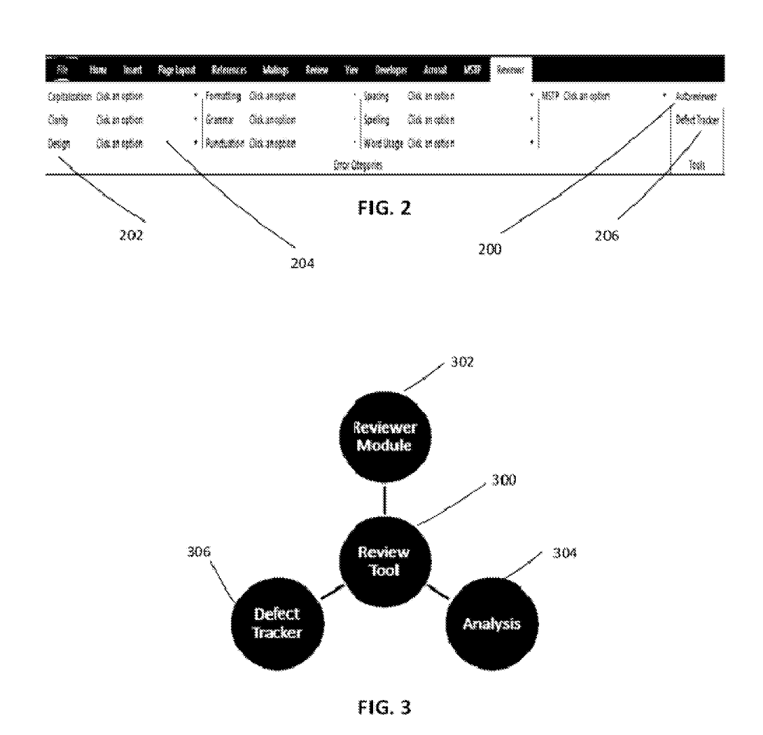

The system disclosed in the invention may involve a reviewer module that comprises a user defined error to be identified in the manuscript. An error is categorized under an error category by a reviewer in the reviewer module. The reviewer module may comprise a standardized comment that describes the error and a suggested corrective action associated with the defined error. In the reviewer module, a reviewer may modify or customize a suggested corrective action associated with each of the defined errors. In one of the preferred embodiments of the present technique, the reviewer uses the tool to perform a review of a manuscript to identify the occurrences of the defined errors in the manuscript. The review may be an automated review, where the tool identifies the instances of errors defined by the reviewer in the reviewer module and automatically inserts a standardized comment describing the error and a suggested corrective action associated with the identified error. The review may be a manual review, where the reviewer identifies the instance of the error and choses the error category from the tool interface as shown in FIG. 2. Then the tool may insert a comment highlighting the identified instance of the error in the manuscript. The comment highlights details on the identified error, the error category, a standardized comment that describes the error and a suggested corrective action to rectify the identified error. The analysis module may take into account the identified instances of error and the comments inserted and provide a statistical insight into the predominant error categories.

The number of errors identified across specific error category or subcategory presents an opportunity for the reviewer to tune the training plan for content developers to address such issues to enhance efficiency going forward, which is hereinafter referred as the “improvement areas.”

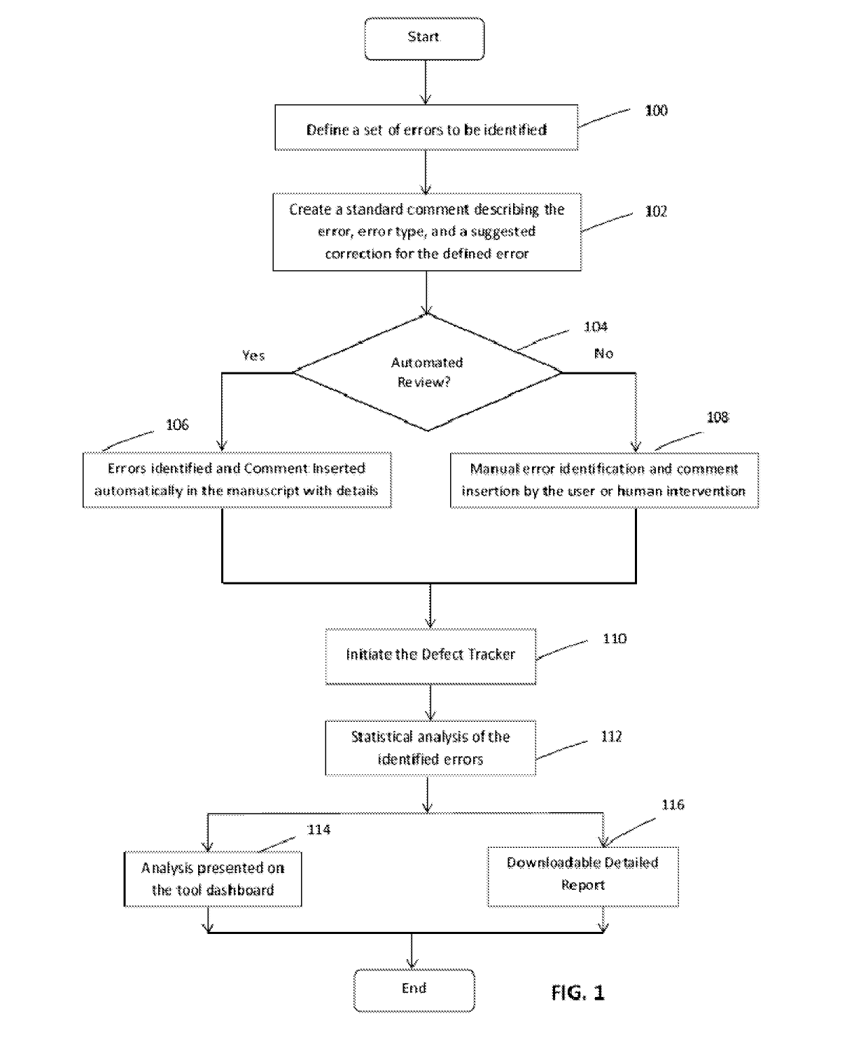

More specifically, FIG. 1 is a block diagram depicting the flow chart of activities with respect to the present technique. The first input in the present technique is the set of errors 100 defined by a reviewer in the reviewer module. In block 100, the reviewer may also define the classification category for the defined error. The classification category may be defined in a hierarchical format. The predominant, but non-limiting error categories include the categories related to formatting errors, grammatical errors, spelling errors, errors related to instructional design, and syntax that may not confer with the Microsoft® Manual Style of Technical Publication (MSTP) guidelines. The reviewer may define a standardized comment, the error type and a suggested correction for the defined error in block 100. Additionally, the reviewer may modify or customize a suggested correction associated with the defined error at a later stage. Such compilation of the reviewer-defined errors, a standardized comment and a suggested correction associated with the defined error are then stored in the reviewer module of the content review tool. The predominant but non-limiting applications where the tool may be best utilized are Microsoft Word® and Microsoft PowerPoint® applications. Optionally, in block 102, a reviewer may associate a standardized corrective action with an identified error, and an action to be performed in case of an automated review. Based on the defined standardized corrective action, the tool may rectify the error identified using an automated review mode. At block 104, the tool offers an option to identify the errors that need to be auto-reviewed, which means with a single click using the present technique, errors across different categories can be identified simultaneously and a comment box may be inserted to highlight the identified error, the category to which the error is associated, which is the error type, a standardized comment describing the error and a suggested corrective action to be implemented to rectify the error. Block 106 represents the process of such simultaneous identification of the errors and inserting of a comment box that details on the error identified, the error type, a standardized comment describing the error and a suggested corrective action to be implemented to rectify the error. Optionally, a reviewer may choose an automated rectification of the identified instances of errors in block 106, based on the standardized corrective action defined in block 102. Using the present technique, in case of ambiguous error categories, a reviewer may choose a manual review mode, wherein the reviewer identifies the instance of the error and chooses specific error category or a sub category through a reviewer interface (as depicted in FIG. 2) to highlight the occurrences of an error. Such process of isolated handling of specific errors or error categories, in contrast to a single click and simultaneous identifications of errors across specified error categories may be described as a manual review technique as represented in block 108. In block 108, as suggested, the reviewer manually reads through the document to identify the instance of an error. At the instance of identification of an error, the reviewer chooses a specific error category or a sub category through a reviewer interface (as depicted in FIG. 2) which automatically inserts a comment box that details on the error identified, the error type, a standardized comment describing the error and a suggested corrective action to be implemented to rectify the error. Thus, the present invention technique enables the reviewer to standardize review comments as well. In a manual review a specific error instance and a specific error category or sub category is reviewed, while in the automated review, the reviewer can simultaneously identify the instances of occurrences of errors across the reviewer specified categories. The subsequent section provides detailed information on manual review. The reviewer may choose either automated review or manual review or a combination of these to review the contents of a manuscript. Without deviating from the spirit of the invention, the reviewer may interchangeably choose the sequence of an automated review and a manual review. Block 110 refers to another vital component of the present invention technique that initiates the analytical process involved in the present technique. The defect tracker component 110 takes into account the comments inserted using automated review technique and also the manual review as preferred by a reviewer. The defect tracker links to the analysis module wherein the analysis module (block 120) identifies the frequency of occurrence of the errors across error categories for a manuscript or the contents under review. The analysis component (block 120) is also capable of providing a statistical insight into the predominant errors and error categories standardized under learning per hour criteria. Further, the statistical analysis includes estimating the frequency of occurrence of a specific error in the manuscript, the frequency of occurrence of a specific error category or frequency of errors across the hierarchical categories of classification. It may also include a comparative evaluation of errors per learning hour for a set of content developers being evaluated by the reviewer. The learning per hour comparison analysis for a content developer with respect to his peers provides an insight into the category classification area where a specific content developer may need improvement in order to enhance his efficiency and output in e-learning systems. The current tools available in the market, including the Microsoft Word® provides for an auto-correct program, which fails to provide such insights that are critical to the e-learning industry and hence, the tool bridges the gap in the e-learning industry. Block 114 refers to one of the mechanisms of the present technique by which the tool presents an insight into the statistical analysis of the identified instances of the error and error categories using a reviewer interface in a graphical or a textual format or a combination of these. Block 116 refers to another output format of the tool by which a reviewer may download the information presented on the interface in block 114 in a Microsoft Excel® spreadsheet. Based on the findings presented in the detailed report, following the identification of areas of improvement for a specific content developer across the defined error categories, a trainer can then design a training plan for enhancing the output and efficiency of a content developer.

FIG. 2 shows a representation of a user interface in accordance with an embodiment of the present technique. A reviewer interface can be viewed as a separate tab on a Microsoft Word® application window when the tool is attached in Microsoft Word® application as template document. Element 200 refers to an automated review mechanism which enables automated identification, and optionally rectification of the identified instances of error. Element 202 refers to the error categories as defined by the reviewer in the reviewer module. For a manual review, the element 204 provides a drop-down option to a reviewer to choose specific sub category to which the identified error category belongs. Thus, a reviewer may manually choose the sub category to which the identified instance of the error may be classified. On selecting a specific category or a sub category, the tool automatically inserts a comment box that details on the error identified, the error type, a standardized comment describing the error and a suggested corrective action to be implemented to rectify the error. Referring back to the flow chart in FIG. 1, a reviewer can then initiate the defect tracker 110 that take into account the error categories identified using automated reviewer 106 as well as manual review 108. As described above, the defect tracker then enables translation of identification of instances and occurrences of errors in the manuscript into valuable insight into the improvement areas.

FIG. 3 illustrative view of the modules of the present invention technique. The review tool of the present technique 300 may comprise a reviewer module 302, an analysis element 304 and a defect tracker 306. The reviewer module 302 enables a reviewer to define the errors, the category to which the defined errors belong, a standardized comment describing an error and a standardized correction associated with the defined error. All these actions can be performed by a reviewer using the interface described above in the previous FIG. 2. The analysis 304 of the identified errors may be performed by the reviewer module to generate insights into the instances and frequency of occurrence of the errors across each of the defined categories. Finally, following the detection of errors and performing the analysis, the defect tracker 306 assists a reviewer to generate an error log. The defect tracker may transfer comments from a manuscript developed in a Microsoft Word® document to Microsoft Excel® and generates an error log. In a non-limiting example, the error log may consist of the following tabs in the Microsoft Excel® workbook: a worksheet that lists all the errors identified in the manuscript, a worksheet that provides a count of errors by category and subcategory, a worksheet that provides a count of errors per learning hour by category and subcategory. The learning and content development organizations use the term “learning hour” to define the amount of content that constitutes one hour of learning content. Further, the workbook may provide a detailed report that may provide textual or a graphical view or a combination of these views across errors categories and subcategories. The detailed report also provides a textual or graphical view or a combination of such views on errors per learning hour. The tool as described herein has a capacity to provide a comparative view of the developer performance in an e-learning program. The defect tracker thus allows a reviewer to perform an instantaneous qualitative and quantitative analysis of errors and take corrective actions to reduce the number of errors. Based on the number of errors under various categories and subcategories, reviewers may develop a focused training and mentoring program to improve the content development skills of content developers.

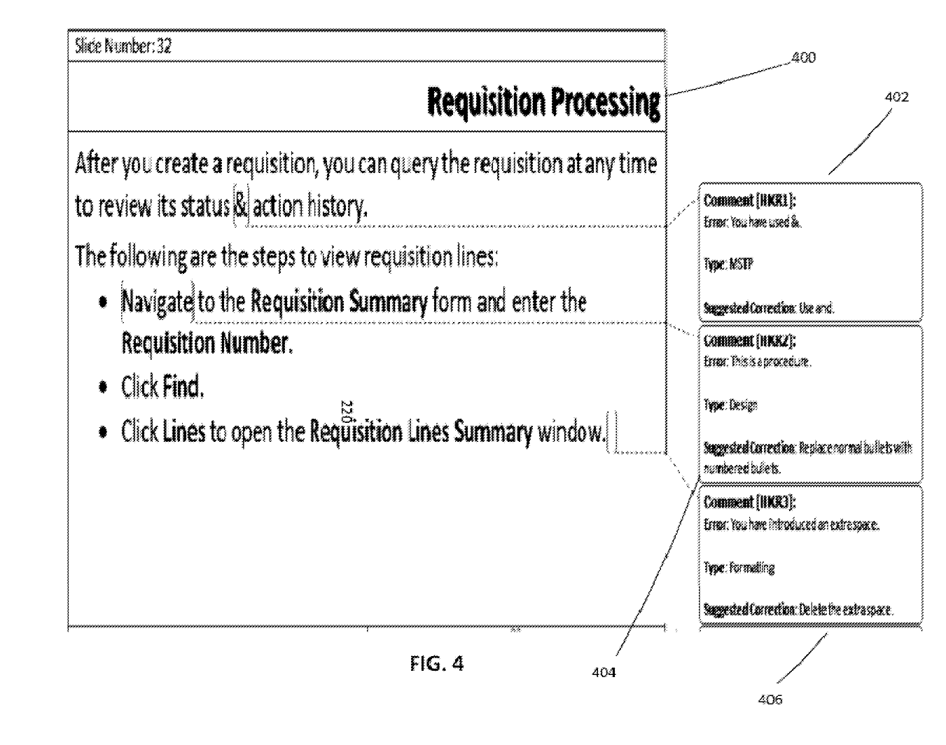

In another preferred embodiment, the present technique may be implemented on a requisition proposition training document or manuscript 400 created using the Microsoft Word® application as shown in FIG. 4. A reviewer may initially define an error, its category, a standard comment describing the error and a suggested corrective action in a reviewer module. This can be defined through the interface as show in FIG. 2. Once the manuscript is prepared, the reviewer uses present technique to identify any occurrences or instances of error, which extends beyond the proof reading capabilities of the Microsoft Word® processor. The present tool identifies the errors, both in an automated review and a manual review, as defined in the reviewer module and automatically inserts a comment box highlighting the error instance. In block 402, the tool identifies usage of an ampersand (&) which may not be a preferred usage under the Microsoft Manual of Style for Technical Publications (MSTP) guidelines. In yet another instance, the comment 404 may be inserted using manual review. Manual review may be preferred in cases where an error to be identified may not be mechanical but may be ambiguous. For instance, the reviewer while manually reading through the manuscript recognizes use of normal bullets instead of numbered bullets, which may be a preferred choice as per the client requirements. In such an instance, a reviewer may place a cursor on the normal bullet and choose a design category 202 and a sub category 204 as represented in FIG. 2. The present system may then automatically insert a comment box detailing on the error type, a standardized comment describing the error and a suggested corrective action as defined in the reviewer module. At 406, the present technique when implemented identifies a formatting error that highlights an extra space that may be need deletion. An extra space in the manuscript is a mechanical error and hence it may be identified using automated review technique, instead of a manual review. The present invention also provides an option to automate a rectification process based on a corrective action as defined in the reviewer module. Alternatively, a reviewer may partially automate the process by choosing the categories across which automatic rectification may be done.

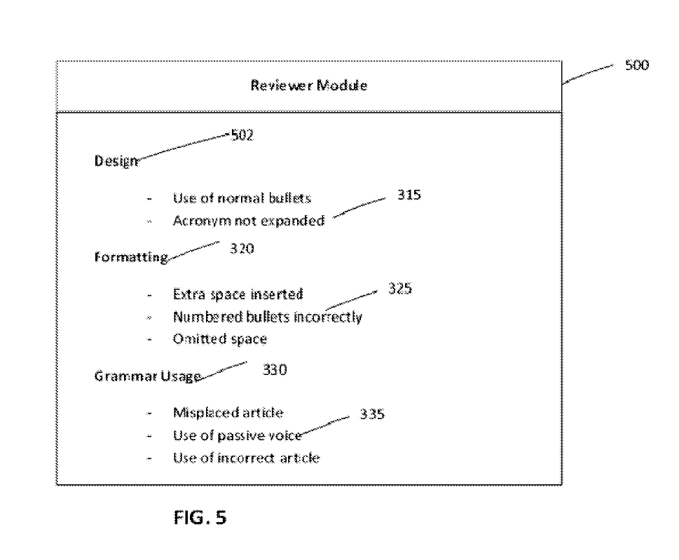

In another preferred embodiment, the present technique may be implemented to assess an individual performance of a developer in an e-learning or training industry. The objective of a reviewer in such instance is to identify the areas of improvement for a content developer. Referring to FIG. 1 of the present invention, the reviewer initially defines an error to be identified and the hierarchy of error categories in the reviewer module. For illustrative purposes, the error category includes MSTP type errors, grammatical usage errors, formatting errors and design related errors. FIG. 5 details on the reviewer inputs in the reviewer module 500 of the present tool. The components 502, 506 and 508 refer to illustrative error categories across which a developer's performance may be assessed. The elements 504, 508 and 512 are the subcategories under each of the defined error categories 502, 506 and 510 respectively, thus creating a hierarchy. The reviewer may also modify or customize a suggested corrective action associated with each of the errors 504, 508 and 512 in the reviewer module. For the purposes of illustration, a standardized comment for an error “Use of normal bullets” in element 504 may have a standardized comment “Use of normal bullets are not appropriate to use in this content,” while a suggested correction may be defined as “Kindly use numbered bullets as per the design guidelines.” With these inputs, the present technique, in a preferred embodiment, the present technique may be implemented in the following manner: A training content development organization may receive a project from a client that involves extensive documentation for implementation of SAP or Oracle ERP packages. The training content development organization May have a team of developers that is actively involved in creating extensive documentation related to training material. The extensive documentation that runs into the volumes of several hundred or thousand pages may require to be reviewed for quality and conformance to standard content development guidelines as a part of client engagement. This may entail identification and elimination of errors before it is actually implemented or delivered to the client for training purpose. In absence of the present technique, the reviewer may have to read through extensive documentation and incorporate corrections at every instance of identification of an error manually across each error category. This is a time consuming process, which moreover does not provide an insight into most common and reoccurring mistakes committed by a content developer. The present technique enables the reviewer to perform a quick review and provides insights into the most commonly occurring errors in a manuscript prepared by a content developer. To review the document, the reviewer may initially install the present tool in form of a template file that provides the reviewer an interface as a separate tab in the Microsoft Word® application. Such illustrative interface as described in FIG. 2 displays options for a reviewer to choose an automated review wherein the reviewer may choose to automatically identify the instances of errors across the error categories and optionally chose an automated rectification of the identified errors. For specific ambiguous error categories, a reviewer may chose manual review of the manuscript. The reviewer may then invoke defect tracker module in order to perform a statistical analysis of the instances of the identified errors. As suggested earlier, the defect tracker takes into account the comments and error category and sub category types identified using automated as well as manual review, which refers to manual identification or errors across chosen category or sub category. The defect tracker 306 may call for analysis 304 of the errors identified in a manuscript under review.

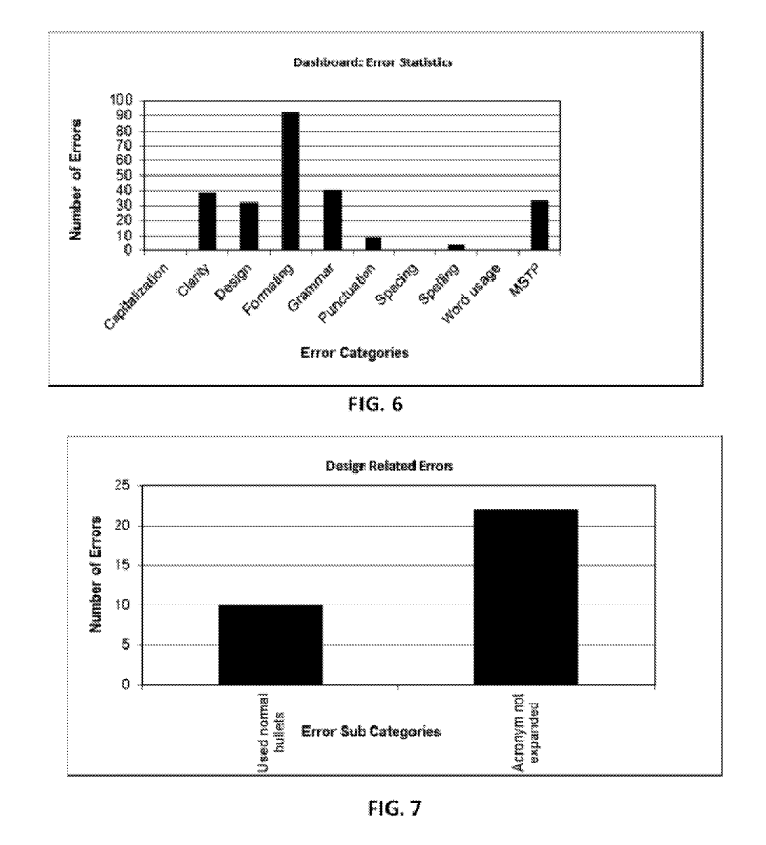

FIG. 6 provides an illustrative view of the contents of a detailed report that may provide an insight into the error categories identified by the present technique. One of the inferences that can be derived from FIG. 6 of the detailed report is that a developer needs to be periodically assessed for rules of formatting for preparation of training content that may going forward enhance efficiency and correctness of the training material prepared by a developer. This provides an overview of the improvement areas for the developer in an e-learning course.

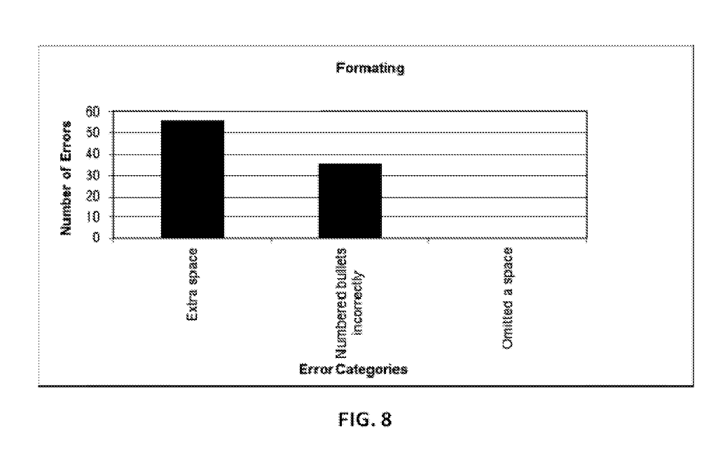

In another non-limiting example, FIG. 7 and FIG. 8 in a detailed report may provide a more granular view of the sub categories across each of the error categories that may reflect an improvement area for a developer whose training content has been reviewed by implementation of the present technique. FIG. 7 highlights that a developer tends to present the content in acronym form, which would most likely fail to help the client understand the aspects of implementation of SAP, Oracle or any other ERP or CRM packages for which the training material was prepared. Hence, the training content developed needs to be revisited or modified for better clarity. In a broader sense, the thirty two errors in the design error category represented in FIG. 6 are split across the sub categories in FIG. 7 that provides a detailed insight into each of the error categories reflected in FIG. 6. Similarly, FIG. 8 reflects that a developer tends to add a defunct space in the content and hence needs to be cautious going forward to avoid such unacceptable syntax error in a formal training document. While addressing excessive usage of acronyms in a manuscript may be a specific client requirement, existence of an additional undesired space in a formal document is a commonly unaccepted syntax across all the documents. In such an event, using the present invention technique, a reviewer may chose an automated review for identification and optionally rectification of syntax errors such extra spaces, while a reviewer may chose a manual review for client specific requirements which may be non standardized or ambiguous error categories. . While the error categories and sub categories stated in the present embodiment are used for illustrative purpose, the utility of the present technique can be extended to several other categories that need to be standardized.

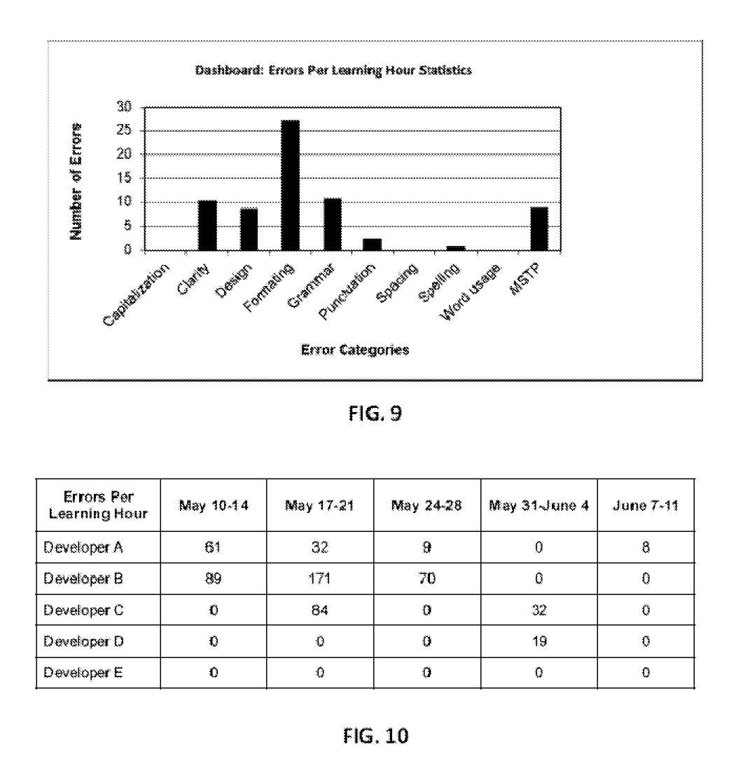

While FIG. 6, FIG. 7 and FIG. 8 refer to a developer specific insight, FIG. 9 and FIG. 10 may provide benchmarking and comparative evaluation of a team of developers. A benchmark needs to be set to assess efficiency of developers in a team when the training content developed by developers in a team may be of varying length or size. Using the present technique, learning per hour feature may provide a reviewer a comparative and benchmarking insight into qualitative and quantitative assessment of variable size of the content prepared by a team of developers. For an illustrative benchmarking process involved in implementation of the present technique, a content development organization may set a benchmark to assess the frequency of occurrences of errors across categories per twenty five pages of the content developed by a developer. In such a case, the number of errors across each identified category is multiplied by the benchmark (twenty five pages in this case), which is further divided by the length or size of the content prepared by a specific developer, which may be in terms of number of pages of content prepared by a developer in a team. The same principle can be applied to assess the number of errors committed by a developer in a unit hour of content preparation. Thus, the current system when implemented may provide for benchmarking learning per hour analysis. FIG. 9 represents a data set standardized as per a benchmarking rule of assessing errors per twenty five pages of content prepared by a developer. It is noteworthy that following standardization, the ordinate value for each of the error categories is significantly reduced. This value reflected in FIG. 9 can then be used to assess the efficiency of the developer when compared to his peers, while the statistics reflected in FIG. 6 represents a standalone assessment for a specific developer.

The present invention can be used beyond benchmarking for comparative periodic assessment of several developers in a team. The functionalities of the present invention technique can be extended to merging and concatenating the periodic assessment data for comparative and efficiency improvement measurements.

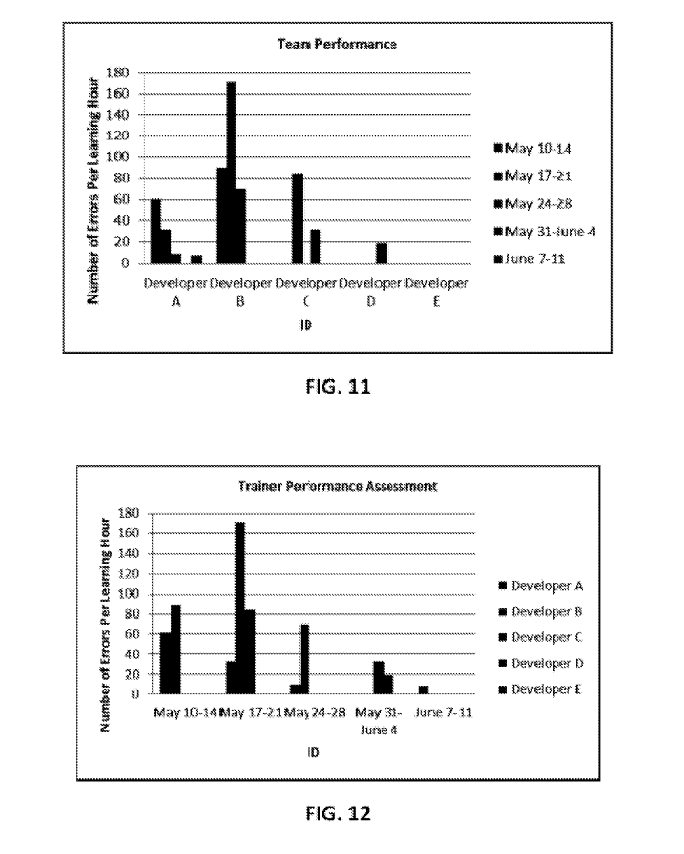

In yet another preferred embodiment, the system of the present invention may be employed to perform a comparative assessment of five developers periodically. The present invention may be implemented in a content development organization across a team of five developers. By implementation of the present technique, the developers A, B, C, D, and E are periodically and comparatively assessed for efficiency in content preparation. As shown in FIG. 10, the periodic assessment data for each developer for a given evaluation period may be collated in a matrix form using the present invention technique. The data reflected in FIG. 10 reflects total errors per learning hour, which can then be bifurcated as stated in above examples across a time period of assessment, an error category and an error sub category for each developer in a team. FIG. 10 is an illustrative matrix view of a data set that reflects summation of errors per learning hour across each of the error categories for a team of developers for a specified periodic assessment timeline. While the data presented in matrix in FIG. 10 may be fetched using element 304 as described in FIG. 3, the defect tracker then may use the same data to generate a graphical representation to generate a comparative analysis of the performance of the developers which is reflected in FIG. 11. Based on the facts and figures presented in FIG. 11 a reviewer may have a comparative view of performance of developers in a team and identify the lead performers. For instance, a reviewer may be cognizant of the fact that Developer E has been consistently outperformed the rest of the team members, while Developer A has improved significantly and consistently following trainings and assessment in the given time period.

While a majority of instances above refer to periodic and comparative assessment of a developer, it is noteworthy that the present invention technique may also be implemented to assess effectiveness of a training program designed for a team of developers. Using the defect tracker as described in FIG. 3, the subtle variation of representation of data presented in matrix in FIG. 10 enables measuring effectiveness of a training plan developed following each assessment. The said variation in representation of a data set is presented in FIG. 12. With respect to FIG. 12, a training plan developer or a reviewer may interpret that the strategy adopted following the assessment outcome for May 17-21 had been effective for a given team of developers. However, it also hints that the strategy adopted initially following the assessment during May 10-14 had not been effective as the total number of errors per learning hour increased. As stated in the examples above, the data presented in matrix in FIG. 10 can be split across error categories to measure effectiveness of specific trainers or reviewers associated with different aspects of training For instance, a content development organization may employ different set of trainers or reviewers to improve developer performance on MSTP related errors as opposed to reviewers that may be involved in design a training program on formatting aspects. A bifurcated representation of such data can help a reviewer design an effective training plan for a given team of developers and assess effectiveness of a training plan as designed and implemented by a a specific trainer or a reviewer.. Alternatively, the present invention technique may also allow a reviewer to set threshold learning per hour error benchmark for each of the defined error categories. In such an event, if the errors committed by a developer exceed the set benchmark, the training plan may be customized to dedicate greater number of training hours for a specific developer on a given error category. Thus, the implementation of the present technique has a wide applicability and utility in e-learning and training development programs which not only helps in assessment of efficiency of content development and thus minimizing the errors, but it may also help in measuring the effectiveness of the training plan or strategy adopted by an organization.

While, the following description is presented to enable a person of ordinary skill in the art to make and use the invention and is provided in the context of the requirement for a obtaining a patent. The present description is the best presently-contemplated method for carrying out the present invention. Various modifications to the preferred embodiment will be readily apparent to those skilled in the art and the generic principles of the present invention may be applied to other embodiments, and some features of the present invention may be used without the corresponding use of other features. Accordingly, the present invention is not intended to be limited to the embodiment shown but is to be accorded the widest cope consistent with the principles and features described herein.

Many modifications of the present invention will be apparent to those skilled in the arts to which the present invention applies. Further, it may be desirable to use some of the features of the present invention without the corresponding use of other features.

Accordingly, the foregoing description of the present invention should be considered as merely illustrative of the principles of the present invention and not in limitation thereof.

What is claimed is:

1. A computer implemented method of content review comprising:
defining, by a computer comprising a processor and a readably attached storage medium, an error, a classification category associated with an error, a standardized text and a suggested correction associated with the defined error, in a reviewer module, wherein the reviewer module is a compilation of the defined errors, an error classification category associated the defined errors, a standardized text and a suggested correction associated with the defined errors;
identifying, by the computer, an error in the content as defined in the reviewer module;
associating, by the computer, the identified error with the error category as defined in the reviewer module;
associating, by the computer, the identified error with a standardized text and a suggested corrective action to be presented to a reviewer as defined in the reviewer module; and
inserting, by the computer, a comment, wherein the comment contains the details on the identified error, the error category, the standardized text and the suggested corrective action associated with the identified error.

2. The method of claim 1 wherein the content is in Microsoft® Word® or Microsoft® PowerPoint® format.

3. The method of claim 1 wherein the suggested corrective action is modified by a reviewer.

4. The method of claim 1 wherein a hierarchy of the error categories is defined in the reviewer module.

5. The method of claim 1 wherein a user interface is used to display a statistical count of each error type.

6. The method of claim 1 wherein the error categories include formatting errors, grammatical errors, spelling errors, and errors related to instructional design or Microsoft Manual of Style for Technical Publication (MSTP) guidelines.

7. The method of claim 4 wherein the suggested corrective action is modified by a reviewer.

8. The method of claim 6 wherein the customized category of errors include use of acronyms or symbols in the content being reviewed.

9. The method of claim 1 wherein a detailed report on the errors is provided to a reviewer.

10. The method of claim 9 wherein the detailed report on the errors provides a count of errors by category and the hierarchy of the error category.

11. The method of claim 9 wherein the detailed report provides a graphical view of the errors per learning hour by category and the hierarchy of the error categories

12. The method of claim 9 wherein the detailed report is used to generate a training plan based on the statistical analysis of the error categories.

13. The method of claim 1 wherein the identified error can be auto-corrected by associating the identified error to a corrective action predefined in the reviewer module.

14. A non-transitory computer-readable medium storing instructions to review a manuscript comprising:
a reviewer module configured to receive user defined information on an error to be identified in a manuscript;
a category classification associated with an error defined in the reviewer module;
a standardized text and a standardized comment associated with an error defined in the reviewer module; and
analyzing by the reviewer module the instances of the identified errors in the manuscript.

15. The instructions of claim 14, wherein a hierarchy of the category classification is defined in the reviewer module.

16. The instructions of claim 14 wherein the suggested corrective action is modified by a reviewer.

17. The instructions of claim 14 further comprising displaying a statistical count of each of the error type through a user interface on a display device.

18. The instructions of claim 14 further comprising identifying one or more predominant error categories and developing a training program thereby.

19. A computer implemented method of content review comprising the following steps:
defining, by a computer comprising a processor and a readably attached storage medium, an error, a classification category associated with an error, a standardized text and a suggested correction associated with the defined error, in a reviewer module, wherein the reviewer module is a compilation of the defined errors, an error classification category associated the defined errors, a standardized text and a suggested correction associated with the defined errors;
identifying an error type in the content as defined in the reviewer module;
associating the identified error type with a standardized text describing the error and a suggested corrective action to be presented to a reviewer as defined in the reviewer module;
inserting a comment box, wherein the comment box contains the details on the error type, the identified error, and the suggested corrective action;
analyzing by the reviewer module the instances of the identified errors in the manuscript to generate a detailed feedback report; and
generating a training plan based on the content of the detailed feedback report.
